(19) United States
(12) Patent Application Publication
(10) Pub. No.: US 2007/0067075 A1
(43) Pub. Date: Mar. 22, 2007

(54) Quick automotive cosmetic repair

(76) Inventors: Michael W. McMillan, Newark, DE (US); Jonathan P. Purifoy, Chicago, IL (US); Keith A. Sena, Canton, MI (US); Mario H. Soto, Foothill Ranch, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/353,477

(22) Filed: Feb. 14, 2006

Related U.S. Application Data
(60) Provisional application No. 60/718,162, filed on Sep. 16, 2005.

(51) Int. Cl. G01M 17/00

(52) U.S. Cl. 701/29

(57) ABSTRACT

This invention is directed to a method for quick repairing multiple cosmetic defects of a vehicle wherein the method comprises the steps of: (a) identifying said cosmetic defect of the vehicle; (b) regulating environmental elements within a controlled perimeter used for positioning the vehicle or an area around the cosmetic defect wherein the environmental elements comprise liquid, air, temperature, light, radiation, humidity, or a combination thereof; (c) acquiring repair data on the cosmetic defect of the vehicle within the controlled perimeter; (d) entering the repair data into a computing device; (e) retrieving one or more repair specification from a first database located in said computing device or located in a host computer in communication with said computing device; (f) estimating repair cost based on the repair specification; (g) obtaining an authorization to repair the cosmetic defect based on said repair cost and the repair specification; and (h) repairing the cosmetic defect based on the repair specification within 0.1 to 8 hours.

### CROSS-REFERENCE TO RELATED APPLICATION

This application claims priority under 35 U.S.C. §119 from U.S. Provisional Application Ser. No. 60/718,162, filed Sep. 16, 2005.

### BACKGROUND OF THE INVENTION

This invention is directed to a method for quick repair of cosmetic defects of a vehicle.

Cosmetic defects of a vehicle are non-structural and visible defects or flaws in interior or exterior parts of a vehicle that are caused by mechanical or chemical actions or by atmospheric conditions. Such cosmetic defects include dents on the body of vehicle, carpet or upholstery damages, glass or windshield cracks. The defects also include paint chipping, discoloration, scratches, small blemishes or other color or coating deterioration. Currently, these defects may be repaired by sending the vehicle to a full service automotive body shop, visiting multiple specialty service providers each is specialized in repairing a particular defect, or using off-the-shelf “Do-It-Yourself” (DIY) repair products by a customer him/herself. The defects may also be left un-repaired.

Currently, if a vehicle is sent to a full service automotive body shop, the vehicle generally must be left at the facility for several days to complete the repair and refinish. For vehicles with cosmetic defects without major structural body damage, it is desirable to have a quick service to repair the defects in a short period of time without having the vehicle in a repair facility for several days. To use specialty service providers, a customer has to identify and visit more than one service providers and transport the vehicle to multiple places. Off-the-shelf “Do-It-Yourself” products may repair some vehicle defects, however, the quality of repair is usually limited. Many defects may not have corresponding DIY products that meet vehicles' repair needs. Some defects, such as dents and windshield damages, may require special tools or equipment that may not be provided by DIY products. Many cosmetic defects, such as scratches on paint finishes, or defects on windshield, may cause further deterioration of the vehicle if left un-repaired for extended period of time. It is to the vehicle owner's best interest to have these cosmetic defects repaired before they develop into major damages. For re-sale of a vehicle, market value of the vehicle will be significantly reduced if cosmetic defects are not repaired. It is desirable to repair cosmetic defects for the vehicle owner or a car dealer before re-sale. To ensure high quality repair that meets original manufactured equipment (OEM) specifications and to meet the increasing customer demand, a professional workmanship, specialized equipment, and “Do-It-For me” (DIF) services are desired.

One approach to solve this problem is to establish professional vehicle services that can provide repairs to more than one type of cosmetic defects. Currently, a number of service providers can repair defects such as paint scratch, dent, interior damages, windshield damages, and metal rim defects. However, these repair services are based on visual assessment on the defects under uncontrolled open environment, such as at a parking lot under variable ambient light. With increasing complexity and variations of modern vehicles, such as variable color effects under different illumination conditions and angles, it is very difficult or even impossible to satisfactorily repair the defects to meet OEM specifications just based on visual assessment under uncontrolled environment. Currently, those repair services also need to identify repair specifications, such as color matching formula, via extensive experimentation and testing therefore increasing repair costs and time. It is therefore still in need for a system to accurately assess and measure cosmetic defects, quickly retrieve repair specification and/or formulation, and satisfactorily repair the defects in a short period of time, preferably within the same work day.

This invention provides a novel method for quick repair of cosmetic defect of a vehicle.

### SUMMARY OF THE INVENTION

This invention is directed to a method for quick repair of cosmetic defects of a vehicle which comprises the steps of:
(a) identifying said cosmetic defect of the vehicle (11);
(b) regulating environmental elements within a controlled perimeter used for positioning the vehicle or an area around the cosmetic defect wherein the environmental elements comprise liquid, air, temperature, light, radiation, humidity, or a combination thereof (12);
(c) acquiring repair data on the cosmetic defect of the vehicle within the controlled perimeter (13);
(d) entering the repair data into a computing device (14);
(e) retrieving one or more repair specification from a first database located in said computing device or located in a host computer in communication with said computing device (15);
(f) estimating repair cost based on the repair specification (16);
(g) obtaining an authorization to repair the cosmetic defect based on said repair cost and the repair specification (17); and
(h) repairing the cosmetic defect based on the repair specification within 0.1 to 8 hours (19).

### BRIEF DESCRIPTION OF THE FIGURE

FIG. 1 shows representative overall process flow chart of the method of this invention.

FIG. 2 shows representative angles for detection and illumination. The degree of angles are for illustration only. A person skilled in the art may determine angles suitable for detection and illumination. An detection device 101 may record images at a determined detection angle 102 with a selected lighting source 103 at a controlled illumination angle 104. A surface of defect 105 may be a flat planar surface, a curved, an edged or an irregular surface. The illumination light may be reflect by the surface of defect 105. A reflection 106 may be unidirectional if the surface is flat and reflective or multi-directional flare if the surface is uneven. The reflection 106 may be absent if the surface is not reflective. A pass-through light 107 may occur if the surface is suitable for light to pass through. The light source and the detection device may be at the same (FIG. 2A) or different sides (FIG. 2B) of the surface of defect.

### DETAILED DESCRIPTION OF THE INVENTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein “vehicle” includes an automobile; truck; semi truck; tractor; motorcycle; trailer; ATV (all terrain vehicle); pickup truck; heavy duty mover, such as, bulldozer, mobile crane and earth mover; airplanes; boats; ships; and other modes of transport that are coated with coating compositions.

As used herein “repair data” of a vehicle include a vehicle's make, model, year of manufacture, color codes, and the vehicle identification number (VIN). The repair data also include codes, labels, part numbers or other identifications provided by manufacturers that are pertinent to the cosmetic defects to be repaired. The repair data further include the nature of the defect, measurement data on or around the defect area generated by an operator, a measurement tool or equipment, such as a gloss meter, photospectrometer, prolifometer, or an X-Ray equipment as necessary to the repair and known to a person skilled in the art. The repair data further include instrument readout, conversions of measurement and readout, or further calculations of the measurement data, readout or conversions.

The term “bay”, “repair bay” or “estimating bay” refers to a structure where a vehicle can be moved in and where inspection, measurement, cost estimating, and/or actual repair work is performed therein.

The term “controlled perimeter” or “perimeter” used herein refers to a perimeter for positioning a vehicle or an area around the cosmetic defect of the vehicle and at least one of the environmental elements within the perimeter is controlled by an environment control device, wherein the environmental elements comprise liquid, air, temperature, light, radiation, humidity, or a combination thereof. The control devices of said environmental elements are well known in the art. For example, liquid can be controlled via valves, pumps, nozzles, heaters, refrigerating devices, vaporizers/electric chargers which are well known in the art to regulate properties of the liquid, such as pressure, temperature, flowing direction, size or electric charge of the droplets, etc. Liquid controls may also provide controllable ways to collect and drain used liquids such as washing wastes. Air may be controlled by fans, vacuum devices, filters or other devices. Air controls may provide ventilation and air flow towards or away from a specific target such as a painted area to remove solvents and to facilitate paint drying. In addition, air controls may be achieved by introducing desired gases, such as nitrogen, into the controlled perimeter. The air may further be dried, moisturized, heated, cooled, or filtered with techniques and devices well known in the art. Temperature controls may regulate temperature for a small area or entire body of the vehicle, or entire space around the vehicle and can be achieved with a conventional heater, an infrared lamp, a hot air fan, an air conditioner, or combinations thereof. Lighting controls may regulate light intensity, light wavelengths, lighting positions, illumination angles, or combinations thereof. Light controls may include switches, optical filters, programmable lighting control devices, a UV light source, a visible light bulb, an infrared light element, or optical devices that can produce light at specific range. of wavelengths or angles, or combinations thereof. Light controls are particularly useful for measuring and repairing color coating defects. Radiation controls provide and regulate radiations such as X-Ray, infrared, electron-beam, ultraviolet, ultrasonic, isotopic, atomic or other radiations. Humidity controls may be achieved by using a heater or a dehumidifier to reduce humidity, or by using a humidifying device to increase humidity, or a combination thereof.

It is consistent with the spirit of this invention that certain conventional controls for vehicle repair may be included within the controlled perimeter, such as diagnostic controls and data controls. Diagnostic controls provide accurate measurements, detections, diagnoses, and recordings of the defect and may have various diagnosis tools and equipments. The diagnostic control may comprise equipment that moves the vehicle to facilitate the desired repair. Data controls provide ways to enter, record and display measurement data and also provide ways to communicate between an operator and computing devices or among different computing devices or systems that may further include client and host computers.

In one embodiment, the controlled perimeter is a bay housing in a building. The bay is equipped with at least one closable door, a set of air ventilation fans, an air condition for temperature control, a heating blower for drying the paint, a set of lights to provide visual and ultraviolet (UV) light illumination, a movable light support that can reproducibly illuminate an object from more than one predetermined angles. In another embodiment, the controlled perimeter is a plastic enclosure comprising at least one of the controls mentioned above. In yet another embodiment, the controlled perimeter is a movable structure with at least one of the controls mentioned above. The movable structure may be affixed to a flatbed truck, a large automobile, or towable by another automobile. The vehicle to be repaired can be moved or driven into the structure through an access ramp, or be moved into the structure with a mechanic device such as a lift. In yet another embodiment, the controlled perimeter is a large tent with at least one of the controls mentioned above. In yet another embodiment, the controlled perimeter has a set of portable lighting controls including a cover in an open space, such as a parking lot. In this embodiment, the portable lighting controls provide one or more selected illumination angles for color measurement. The cover included in said lighting controls prevents ambient lights from interfering with the color measurement. In yet another embodiment, the controlled perimeter is a set of portable UV lights, lighting controls and a portable covering device. In this embodiment, the portable light controls regulates the UV illumination angle and the portable covering device blocks ambient light providing a darkened space for viewing and recording the images of the defect under the UV light illumination. A suitable covering device can be a black cloth cover or a light shielding adaptor that covers a portion or entire body of the vehicle. A suitable detection device can be a still camera, a video recorder, a photometer, or a portable protractor apparatus described in a commonly owned U.S. Pat. No. 6,891,617, wherein from column 3, line 1 to column 6, line 49 of the above mentioned U.S. Patent is incorporated herein by reference.

The purpose of the controlled perimeter is to allow for precise and accurate assessment of a cosmetic defect on the vehicle during estimating and repairing process. For example, a controlled perimeter with scientifically designed lighting provides the estimator and customer an optimal space for pinpointing dents, scratches and other damages. Traditionally, estimating takes place in a parking lot where glare, reflections and other elements obstruct viewing, causing incorrect damage assessment, which leads to poor quality and customer dissatisfaction. By creating the controlled perimeter, customer's vehicle will receive a thorough examination resulting in a complete and high quality repair.

The term “light” in “lighting”, “lighting source”, or other light related terms or phrases used herein refers to lights, radiations, rays, beams at visible and non-visible wavelengths.

A “detection device” refers to a device that can detect signals. A detection device may be a still picture camera that records images on films or digital media, a video camera, a scanner, an X-ray detector, a photometer, a spectrometer, a profilometer, or any other devices that can detect signals. The device may be capable of recording the signals or be connected to a recorder that is capable of recording the signals. In one embodiment, a digital camera detects and records signal in its memory card. In another embodiment, a video camera detects and records signal on a video tape. In yet another embodiment, a scanner detects signal and sends the signals to a computer and record the signals on the computer's hard drive. In yet another embodiment, a spectrometer detects signal and records the signal as instrument readout on a paper printout. In yet another embodiment, a photometer detects and records signals in its memory or hard drive.

The term “processing system” used herein refers to a single or a combination of more than one piece of computing devices, software, hardware, databases and necessary wired or wireless connections. In one embodiment, the processing system comprises a desktop computer with a set of conventional spreadsheet software, a web browser, and at least one connection to at least one database. In another embodiment, the processing system comprises a portable computing device with software to process data and a wireless connection to another computer. In yet another embodiment, the processing system comprises a PDA with a wireless connection to a laptop computer, wherein the laptop computer is loaded with software and databases. In yet another embodiment, the processing system comprises a PDA which communicates with a laptop computer, wherein the laptop computer is loaded with software and further communicating with a host computer where databases reside.

The term “computing device” used herein refers to a desktop computer, a laptop computer, a pocket PC, a personal digital assistant (PDA), a handheld electronic processing device, a mobile phone, a smart phone that combines the functionality of a PDA and a mobile phone, or any other electronic devices that can process information automatically. A computing device may have a wired or wireless connection to a database or to another computing device. A computing device may be a client computer that communicates with a host computer in a multi-computer client-host system connected via a wired or wireless network including intranet and internet.

The term “repair specification” used herein refers to formulations, procedures, instructions, or any other information that guides an operator to repair the defect. In one embodiment, a repair specification comprises a color formulation, a color mixing procedure and a paint application method to match and repair a color defect. In another embodiment, a repair specification comprises an instruction to find an access to the back of a metal dent on the vehicle's body with a specific make and model, a recommendation for tool selection, and a method for moving the dented metal portion to its pre-damage state. In yet another embodiment, a repair specification comprises an instruction on how to cut out a damaged upholstery, materials needed for repair, a procedure for repair and the time needed for the repair to be set before being touched. In yet another embodiment, a repair instruction comprises instructions, materials, tool recommendations and procedures on how to repair a damaged windshield. A standard repair specification may be readily available from one database for some common defects. An operator may use the specification directly without modification. It is possible that more than one set of repair specifications are available. Under this situation, the operator may make a determination on which set to use or may choose to combine more than one sets. The operator may choose to modify a standard repair specification to fit the need of individual repair. In an event that a standard repair specification is not available for the specific defect, an skilled operator may identify a standard repair specification for a similar defect and modify it to provide the best repair.

A “database” used herein refers to a collection of related information that can be searched and retrieved. A database may be a searchable electronic text document, a searchable PDF document, an Microsoft Excel® spreadsheet, an Microsoft Access® database, an Oracle® database, or a Lynx database, each under respective registered trademark. In one embodiment, the database is part of ColorNet® from DuPont, Wilmington, Del. In another embodiment, the database is a paint formula database loaded into a PDA's memory card wherein the color formula can be retrieved via a vehicle identification number (VIN). In yet another embodiment, the vehicle color matching database is residing at a remote location and accessible from terminals or client computers, as described in U.S. Pat. No. 6,522,977, and herein incorporated by reference.

The term “cosmetic defects” refers to visible defects of a vehicle that are non-structural. Cosmetic defects may include coating and paint defects, dents of a vehicle body, vehicle interior surface and finish damages, glass and windshield damages, vehicle exterior surface damages, or combinations thereof. Examples of coating and paint defects include paint chips, discolorations, scratches, or small blemishes. Examples of dents may include small dings and dents on metal or plastic parts in the interior or exterior of the vehicle's body. Vehicle interior surface and finish damages may include cuts and wears of the interior surfaces and finishes. Glass and windshield damages may include cracks, scratches, or breakages of window glasses or windshield. Vehicle exterior surface damages may include scuffed bumpers, damages to side door panels, mirror casings, rims or other exterior parts of the vehicle. Cosmetic defects may also include flaws and other visible non-structural defects of the vehicle that are caused by mechanical or chemical actions or by atmospheric conditions, e.g., hail or acid rain.

Simple, low cost and convenient repairs of these cosmetic defects of vehicles, without requiring the vehicle to be in a repair facility for more than a day, has been a problem since conventional repair or refinish systems are not adaptable to such low cost convenient repairs. The advantage of the novel repair method of this invention is that it is simple, low cost, convenient and the repair can be done within a few hours of time without tying up the vehicle at the refinish facility or having the owner or customer to spend time dropping off and picking up the vehicle at multiple repair facilities for different defects.

The term “customer” used herein refers to a person or persons who requests repair of the vehicle. A customer may be the owner of the vehicle or a representative or an agent of the owner. The customer may also be a person who has temporary possession or responsibility of the vehicle, such as a person who rents a rental car.

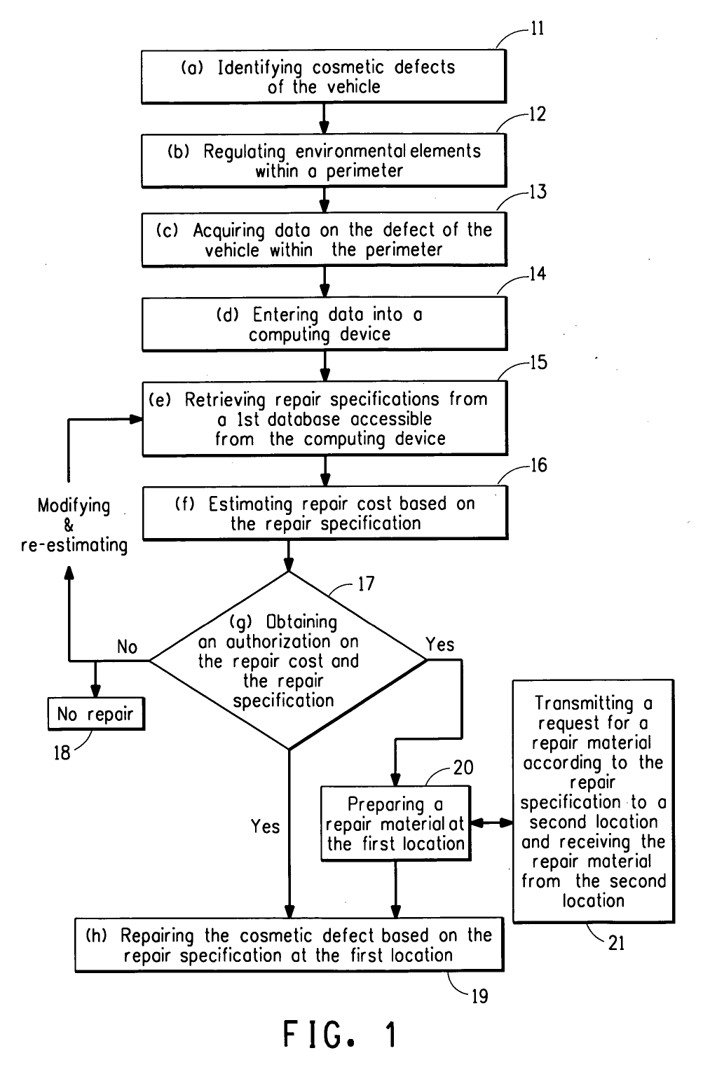

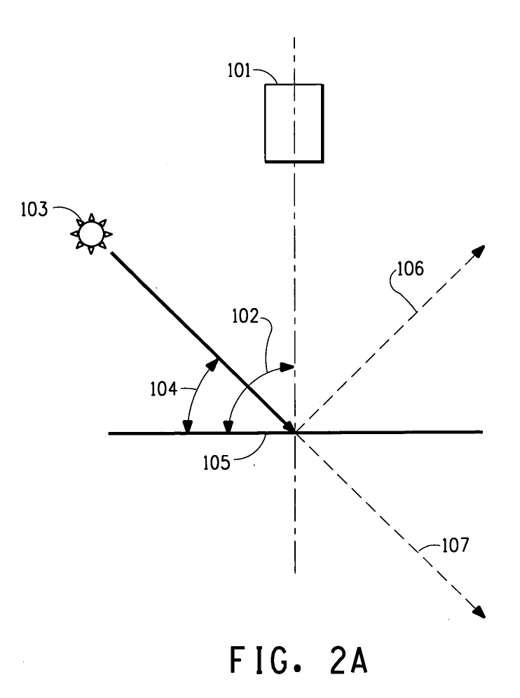

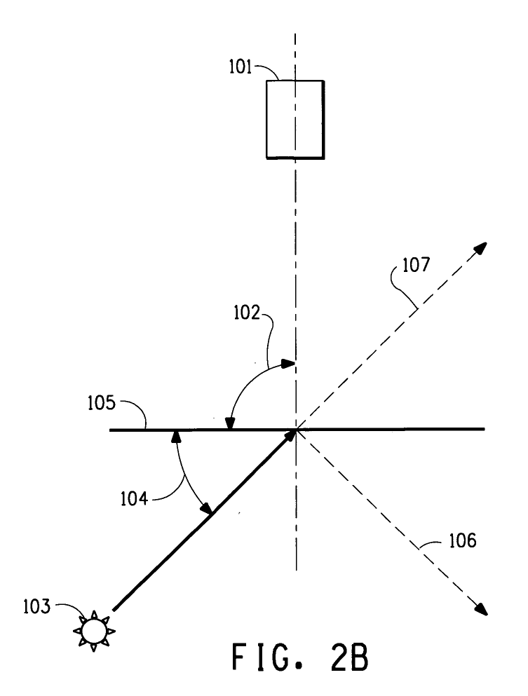

FIG. 1 shows a process flow chart of the quick cosmetic repair system of this invention. In step (a), an operator identifies at least one cosmetic defect of a vehicle (11). The operator may choose to mark the defect on the vehicle body with a removable marker pen or describe on a worksheet with the location parameters of the defect. Suitable worksheet may have outlines of a vehicle pre-printed so the operator may check the corresponding location of the outline to indicate the location of the defect. In this step, the operator also identifies and record the nature of the defect. The operator may further prepares the vehicle for inspection and determines what measurements are needed at a work site where a repair is to be performed and a perimeter with environment control devises is located. This location is hereafter referred to as a first location. In this step, areas of the vehicle to be repaired may be washed with water, detergent, or solvent and subsequently rinsed and dried. Optionally, the entire vehicle body may be washed. Any dirt or foreign object that may interfere with the inspection and assessment of the defect may be removed by physical, chemical means, or a combination thereof. A typical physical means may include pealing, scraping, sanding, or any other methods using physical force. A typical chemical means may include the use of chemical solvent or detergent, such as for the removal of dried tar or grease.

In steps (b) (12) and (c) (13), the operator regulates the desired environmental elements in the controlled perimeter and acquires repair data on the defects. The vehicle's make, model, year of manufacture, and the vehicle identification number (VIN) may be part of the data acquired by the operator. The data may be acquired with data acquisition means such as measurement instruments and detection devices. Size of the defect area may be measured at this step. For a defect in coating and paint, lighting may be controlled. Other environmental elements, such as temperature or humidity, may also be controlled to ensure accurate data acquisition. The information is then entered into a computing device in step (d) (14). The steps (b) through (d) may be repeated until all necessary data are collected and entered into the computing device and the associated processing system. In one embodiment, the VIN and the color code are acquired and entered into a portable electronic device such as a personal digital assistant (PDA) which has a color formulation database loaded into its memory. The color formulation in the PDA is retrievable via a vehicle's VIN and color code. In another embodiment, the data on color measurement are obtained by comparing a set of color chip to the vehicle's defect area within a controlled perimeter where lighting is regulated. Specific identification of the color chip is then entered into a computer for retrieving color formulation. In yet another embodiment, the color of the defect area of the vehicle is determined and directly entered into a processing system with a color measurement device, such as computerized ChromaVision® system provided by DuPont, Wilmington, Del. ChromaVision® is a trademark of DuPont, Wilmington, Del. In yet another embodiment, a close examination in the controlled perimeter discovers that the area around the paint scratch originally identified is also damaged due to long term exposure to moisture. The area to be repaired is then re-measured and the data is used for steps of cost estimate and repair.

The data on color measurement may be obtained by using a multi-angle color measurement system, such as a portable protractor apparatus described in a commonly owned U.S. Pat. No. 6,891,617, herein incorporated in by reference. Multi-angle color measurement ensures better color match, especially for paints or coatings containing metallic flakes or particles. Details on multi-angle color measurement and methods for color matching are described in a commonly owned U.S. Pat. Application No. 60/678310, filed on May 5, 2005, herein incorporated in by reference.

In step (e), a repair specification is retrieved from a first database that is accessible from the computing device (15). In one embodiment, paint formulas and variants thereof are retrieved from a manufacturer's paint database accessible from the computer that the operator is using based on the VIN and color code of the vehicle. In another embodiment, color formulas and variants are retrieved with the ChromaVision® system from the associated VINdicator™ and ColorNet® database and tools, all provided by DuPont, Wilmington, Del., under respective trademarks. Step (e) is repeated for each defect that is to be or intend to be repaired.

In step (f), a repair estimate is provided for each cosmetic defect based on the repair specification (16). A sum of cost is also provided. The estimate is preferably calculated with a computer program, such as a spreadsheet or other office calculating programs located in the computing device. The estimate results may be printed on a piece of paper or presented on a terminal screen connected to the computing device. The cost estimate includes material costs and labor charges based on the repair specification, plus applicable taxes, regulatory fees such as waste disposal fees, communication charges such as network connection and database access fees and other costs related to the repair. For a paint repair that requires the mixing of multiple components to match a specific color, cost estimate may be complicated. In an Example described below, 6 different toner colorants are needed to generate the desired color. In that embodiment, cost estimate is calculated based on unit price and the amount of each toner colorant plus other charges such as labor charge and database access fees. Accurate repair cost estimate is important to the repair business: too high estimate may turn away a customer while too low may not cover the actual cost. Many regulatory authorities impose regulations on repair cost that the final cost may not exceed certain percentage such as no more than 110% of an estimate.

In step (g), the repair is authorized either based on the repair cost estimate or on a “No-Exceed” limit basis (17). Since most of the cosmetic repairs are in the low cost range, a customer may choose to pre-authorize a “No-Exceed” limit before the cost estimate is generated to speed up the repair. If an estimate is considered too high or exceeds the pre-authorization, the customer is contacted. The customer may choose to repair only part or a subset of the cosmetic defects identified or select a different repair methods or process if it is available. The repair operator may modify the repair specification or material selection to reduce repair cost. A second estimate is provided if necessary. The process may be repeated until a desired repair selection, repair specification and repair costs are finalized and a final authorization is obtained. The customer may choose not to proceed with the repair therefore terminating the repair (18). In most cases, the authorization may be provided by a customer who requested the repair. The authorization may also be provided by others who have responsibility or interests in the vehicle, such as an insurance company or its agent, a car rental company or its agent, or a lien holder of the vehicle such as a Bank. The authorization may further be provided by a business manager, the owner or a person who has business and financial interest on the vehicle repair facility to ensure that the fees charged to the customer can cover actual cost of the repair. The authorization may be in the form of a physical signature on a printed repair estimate or in the form of digital signal via an authorization device. Suitable authorization device includes, but not limited to, electronic key pad, a mouse connected to the computing device, a touch screen, voice recording device, photo imaging device, a digital hand-writing input device, a digital keyed input device, a digital graphic input device, or any other electronic devices that may transmit the authorization into an electronic signal that authorizes the repair. A non-digital authorization, such as a signed paper authorization form, may have a digital or digital readable identifier such as a bar code, an radio frequency identification (RFID), a digital readable numeric code, a perforation code, or a combination thereof. In this invention, a digital authorization is preferred. A digital authorization that can be stored in and retrieved from a computing device is further preferred. A digital authorization that can be stored in and retrieved from a database that is accessible from a computing device is even further preferred.

Different types of computing devices may be used. In one embodiment, a desktop computer with at least one database loaded into its hard drive is used for storing the repair data and for retrieving repair specifications. In another embodiment, a desktop computer with network connection to at least one database located in a host computer is used. The network connection may be wired or wireless as known to a person skilled in the art. The connection may also be through internet. In yet another embodiment, a portable device, such as a PDA or a laptop computer, with necessary data down loaded into its memory or hard drive may be used. In another embodiment, the portable device may have wireless connection to at least one database residing on a separate computing device. In yet another embodiment, a portable device or a client device may have wired connection to at least one database residing on a separate computing device or a host computer device. In yet another embodiment, the portable device is connected to at least one database through wired or wireless internet connection.

In step (h), repair is performed based on the repair specification (19) by a person or a group of persons with necessary conventional repair means, such as repair tools and materials. The repair may be performed in the controlled perimeter that is the same or different from the ones used in steps (a) through (c). In one embodiment, the vehicle is inspected and measured in a first controlled perimeter, such as an estimating bay that has lighting controls and color measurement and matching tools for color determination, and then moved to a second controlled perimeter with paint brushes, spray guns, ventilation control and temperature control means for paint repair and drying. In another embodiment, the vehicle with a windshield defect and a seat upholstery defect is inspected and repaired in one controlled perimeter equipped with a lifting equipment. The vehicle is then moved to another controlled perimeter with light control, sanding tools, paint tools and ventilation controls to repair a bumper defect. An effective period of time for the repair is within the same day, preferably within 8 hours, more preferably within 6 hours, further preferably within 4 hours, even further preferably within 2 hours, most preferably within 1 hour, from the time the repair authorization is obtained.

Materials needed for repair, such as a pre-made and ready-to-spray paint may be readily available at the work site within or adjacent to the perimeter where the defect is identified and repair data are acquired (a first location). Under such situation, no additional step is required and the operator uses the readily available material to repair the defect according to the repair specification at the first location.

An optional step may be needed if some or all of the repair materials need to be prepared (20). In one embodiment, a specific color needs to be mixed from a number of color ingredient. Under this situation, the operator needs to prepare the repair material by mixing the ingredients according to the color formulation in the repair specification.

A further optional step to transmit a request for and to receive the repair material (21) may be needed if some or all of the repair material is not available at the first location. In one embodiment when some or all of the ingredients that are needed to mix a paint of desired color according to the specific formulation is not available at a first location, a request for repair materials is transmitted from the first location to a second location such as a central hub or a warehouse or another repair facility. The request may be made via a telephone call through a land phone or a cell phone, a fax, an e-mail, a web-enabled request form, a direct high speed internet link between computing devices at the first location and the second location, two way radios, or other communication means well known in the art. The required materials are then prepared and delivered to the first location within a specified time, such as within 2 hours, preferably within 1 hour, further preferably within 0.5 hours, from the time of the request. The operator is then using the materials to repair the defect according to the repair specification. In one embodiment, a paint of desired color is requested by an operator at a work site, mixed at a central hub and then delivered to the work site within 1 hour from the time of the request.

In the spirit of this invention, steps of this invention may be repeated and/or performed in different sequential orders as necessary unless otherwise specified. In one embodiment, an authorization step (g) for “No-exceed” is performed before the steps (a) or (b).

Optionally, alongside the controlled perimeter, such as an estimating bay, is an area for the customer and an operator to discuss each of the cosmetic repair services available, including color matching capability. Further optionally, amenities such as (1) a resting space, where a customer may seat, get food and/or drink; (2) an entertaining facility, where a customer may read, watch TV, listen to radio or music, play games, connect to wired or wireless internet via a computer, a PDA or a cell phone; (3) a car care education facility, where a customer may get car care education; (4) a car care products selection facility, where a customer may view and/or obtain car care products, product catalogs, samples, videos or photographs and become familiar to the car care services and offerings; and (5) a future car care service scheduling facility, where a customer is provided with opportunities to schedule future services. The amenities may be free of charge, on a pay-for-service basis, or a combination thereof.

The quick repair method further optionally provides a step of recording data of a defect before and after the repair. The data of the defect may be images, spectrometer readings, prolifometer measurements on the surface, or other instrument measurement data of the defect. In one embodiment, a set of three images of a defect are recorded with a detection device such as a digital camera from three detection angles: 45 degree, 90 degree and 135 degree relative to the surface of the defect with a fixed 45 degree illumination angle and a lighting source at visible light wavelengths. In another embodiment, images are recorded with an UV light source and a detection device such as a camera equipped with at least one optical filter suitable for imaging under the UV lighting. In yet another embodiment, video images are recorded with a detection device such as a color video camera at a fixed detection angle such as 90 degree relative to the surface of a defect, while a light source is moving from about 45 degree to about 135 degree illumination angles relative to the surface of the defect. In yet another embodiment, the smoothness of the surface of a defect and the surrounding area is measure with a prolifometer. The data can be captured on a film or in a digital format. The data can be showed on a computer monitor, a TV screen, a projector screen or any other display devices. The data may also be printed onto papers, textiles, or any other surfaces that is suitable for printing the data onto. It is preferred to capture and store the data in a digital format. It is further preferred to capture and store the data in a retrievable format with descriptive file name, codes, index, or other computer readable identifiers.

A quick repair facility may be stationary, mobile or a combination thereof. A stationary facility refers to a quick repair facility that is in a building or is a part of a building, or otherwise not mobile. A mobile facility refers to a quick repair facility that can be moved from one location to another. In one embodiment, the estimate bay is in a mobile truck while the repair bay is stationary. In another embodiment, entire quick repair facility is stationary including an estimate bay with controlled lighting, a repair bay with ventilation and temperature control. In yet another embodiment, entire quick repair facility is in a mobile truck.

More than one quick repair facilities may form a network system or a hub-satellite system and may share one or more central hub. The central hub is to keep stocks of materials such as different ingredients for mixing colored paints. The hub may have additional capabilities for preparing repair materials according to a repair specification such as mixing a colored paint. One or more of the quick repair facilities in the hub-satellite system may serve as the central hub. In the hub-satellite system, a vehicle may be examined and repaired in a first facility while materials for repair may be prepared at the first facility, or prepared at a second facility or the central hub and delivered to the first facility upon a request from the first facility. It is preferred that the repair materials can be prepared at the second facility or the central hub and delivered to the first facility within the same work day, further preferred within 8 hours, more preferred within 4 hours, even more preferred within 2 hours, most preferred within 1 hour, from the time the request is made. The hub-satellite system may have a central control facility comprises communication means for communicating with the quick repair facilities in the system, storage facilities for storing repair equipment, materials or ingredients for preparing said repair materials, such as toner and paint of different colors, and a transportation means to supply said quick repair facilities with said material, said repair equipment, or a combination thereof. One embodiment of the communication means is a network of computers connected via wired or wireless connections. In this embodiment, a request is entered into a first computer at one of the quick repair facility and then transmitted to a second computer at the central control facility. The transportation means may be a designated driver and a transportation vehicle.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Example 1

### Paint Touch Up for Color Match and Repair

In this example, the vehicle to be repaired is a blue 2002 Ford Escort that has a small key scratch on the driver's door. The customer pre-authorizes the repair. The operator moves the vehicle into a bay and identifies the vehicle paint code from the Vehicle Identification Plate having the VIN inscribed thereon. The plate is located on the driver side door or door frame. The VIN on the Vehicle Identification Plate indicates a color code “CX”. This information is entered into a PDA having vehicle manufacturer's database and color formulation database loaded into its memory card. The paint formula and the color variants for the vehicle, the year and color code are displayed on the PDA screen. For color formulas, there is a set of color chips provided by the paint manufacturer. The operator uses lighting controls in the bay and the color chips to ensure the selection of the best color match.

Once the best matching color is identified, the operator then enters his Mix Quantity, or the amount of paint that is needed. The operator makes a judgment on the quantity of paint required for a particular repair based on the measurement data on the size of the defect area. In this situation, a pint of paint was formulated. The PDA's software calculates the weight of the various constituents required to formulate the paint and displays the toner colors and weights, e.g., for a US pint, to mix to form the repair paint: The toners used are toners of a commercial Standox® Mixing Machine available from E.I. du Pont de Nemours and Company, Wilmington, Del., USA. In this embodiment, different amounts of 6 toner colorants: Toner 571 (15.92 parts), Toner 811 (33.21 parts), Toner 885 (37.14 parts), Toner 593 (41.19 parts), Toner 008 (44.54 parts) and Toner 570 (44.65 parts) are used to generate the desired color. The cost calculation can be obtained based on the unit cost and the amount of each paint component needed. In this embodiment, the final cost does not exceed the customer's pre-authorization.

The on-going total weight of the mixture is also displayed at each stage of mixing. The operator mixes the appropriate toners and volumes into a mixing cup and transfers it to a spray gun.

The repair process follows conventional body shop practices wherein there is some surface preparation of the scratch required and the scratch is filled with a putty and the surrounding paint area masked and the area is lightly sanded. The operator then sprays the paint onto the area to be repaired using conventional spray color matching techniques. The amount of paint used to effect the repair is about 1/100th the volume of paint required for a typical body shop repair of similar damage. The paint is allowed to dry for about 5 minutes and cures in about 10 minutes. A clear coat was then applied only to the repair area and the area was slightly buffed resulting in an un-noticeable paint repair. Total time for repairing this cosmetic defect is about 1 to 2 hours.

### Example 2

### Paint Preparation and Repair

In this example, an operator is at a car dealer's work site to repair a paint scratch of a vehicle. The scratch is examined and measured. A color formulation is identified based on the data acquired as described in Example 1. The operator, however, lacks all the ingredients at the work site to prepare for the paint with the desired color. The operator transmits a request for materials including the color formulation and quantity from a computer at the work site to a second location where all the ingredients are available based on an inventory database accessible from the computer the operator is using. In this example, the second location is a central hub with stocks of paint and color ingredients, paint mixing and packaging capability. The transmission in this example is achieved via a direct high speed internet link between the work site and the central hub. The operator may transmit the request via other wired or wireless communication means such as telephone, fax, cell phone, two way radio, or e-mail. Paint of the desired color and quantity is mixed at the central hub, sealed in a container suitable for transporting paint and delivered to the operator at the work site. The paint is then applied as described in Example 1. Total time for repairing this defect is about 2-3 hours including the time for paint mixing and delivery.

### Example 3

### Upholstery and Interior Repair

In this example, a cut is present on the back seat surface of a vehicle. An operator examines and marks the defect area to be repaired. Repair materials are selected by the operator under a controlled lighting condition to ensure the best color and texture match. An estimate is provided to the customer based on the materials selected and the size of the damaged area. An authorization is obtained. The cut area is cleaned with conventional method. A conventional upholstery repair kit that is in stock at the repair facility is then used to repair this defect. This repair takes about 20-40 minutes.

### Example 4

### Metal Dent Repair

A small dent is present on the external metal surface of a door panel of a vehicle. An operator inspects the defect and acquires vehicle identification data including make, VIN, color, model year. Based on the vehicle identification data, the operator retrieves door panel structural information from the manufacture's manual. According to the structural information (part of the repair specification), part of the interior panel of the door will have to be removed in order to access the back side of the dent. A repair estimate is generated according to the labor required to remove and to re-attach the interior door panel and to repair the dent. An authorization is obtained from the customer. A well known industry acceptable technology is performed to insert a tool to the back side of the door panel and push the dent to its undamaged state. This dent repair is finished within 20 to 45 minutes.

If paint of the dented area is also damaged, it may be repaired according to the process described in Examples 1 or 2.

### Example 5

### Windshield Repair

A crack is visible on the front windshield of a vehicle and is to be repaired. An inspection using a combination of transmittal and reflective lighting source identified 3 small additional cracks at corners of the windshield. An operator identifies the vehicle's make, model and year of manufacture and retrieves information on suitable replacement. Cost estimates of repairing all 4 cracks and replacing entire windshield are generated and provided to the customer. The customer authorizes the windshield replacement. The damaged windshield is removed and a replacement is made according to conventional industry practice. This repair may be done within 30 to 100 minutes.

### Example 6

### Bumper Repair

A large scuffed area is present on the rear bumper of a vehicle. The scuffed area is about 5 inch wide and 6 inch long. An X-Ray examination revealed no further damage to the vehicle's body structure. Repair specification is retrieved from a database located on the operator's computer where the repair specification requires surface preparation and painting of the scuffed area. Repair cost estimate is generated based on the repair specification and the size of the area to be repaired. The customer authorizes the repair. The damaged area is cleaned, primed, filled with a putty and sanded according to industry practices well known to a person skilled in the art. The damaged area is then painted with the matching paint identified and mixed according to processes disclosed in Examples described above. This repair takes 1-2 hours to complete.

### Example 7

### Repair of Multiple Defects of a Vehicle

In this example, a vehicle has a dented exterior side door panel, a paint scratch around a keyhole, and a cut on a seat surface. The customer requests a cost estimate for repairing individual and all of the defects. An operator examines and identifies the defects, acquires data of the defect including sizes of areas to be repaired. Based on the data acquired, the operator retrieves repair specifications from a database residing on the computer located in the repair facility for dent repair, scratch repair and seat cut repair, respectively. Cost estimate for each repair is generated based on the repair specification for the particular defect. Total cost estimate is also generated based on the cost of each individual repair. The customer authorizes the repair of all three defects. The operator transmits a request for paint with the matching color and a request for the fabric that matches the seat surface to a central hub. While waiting for the requested materials, the operator repairs the door panel dent according to the respective repair instruction as described in the examples of this invention. The paint scratch and seat cut are repaired after the materials requested are delivered. Total repair time for all the defects is about 2-3 hours.

What is claimed is:

1. A method of repairing cosmetic defects of a vehicle comprising the steps of:
(a) identifying said cosmetic defect of the vehicle (11);
(b) regulating environmental elements within a controlled perimeter used for positioning the vehicle or an area around the cosmetic defect wherein the environmental elements comprise liquid, air, temperature, light, radiation, humidity, or a combination thereof (12);
(c) acquiring repair data on the cosmetic defect of the vehicle within the controlled perimeter (13);
(d) entering the repair data into a computing device (14);
(e) retrieving one or more repair specification from a first database located in said computing device or located in a host computer in communication with said computing device (15);
(f) estimating repair cost based on the repair specification (16);
(g) obtaining an authorization to repair the cosmetic defect based on said repair cost and the repair specification (17); and
(h) repairing the cosmetic defect based on the repair specification within 0.1 to 8 hours (19).

2. The method of claim 1, wherein the cosmetic defects comprise: coating and paint defects, dents of a vehicle body, vehicle interior surface and finish damages, glass and windshield damages, vehicle exterior surface damages, or a combination thereof.

3. The method of claim 1, wherein the repair data comprise data on color measurement.

4. The method of claim 1, wherein the repair specification comprises a color formulation.

5. The method of claim 4 further comprising a step of mixing colors based on said color formulation.

6. The method of claim 1 further comprising a step of preparing a repair material based on the repair cost and the repair specification, wherein the repair material is prepared at a first location that is within or adjacent to the controlled perimeter, a second location, or a combination thereof.

7. The method of claim 1, wherein the repair authorization is obtained in a digital form.

8. The method of claim 1 further comprising a step to modify the repair specification.

9. The method of claim 8, wherein the modified repair specification is stored in a second database.

10. The method of claim 1, wherein the computing device is selected from: a desktop computer, a laptop computer, a PDA, a pocket PC, a mobile phone, a smart phone, or a combination thereof.

11. The method of claim 1 further comprising a step of providing amenities to a customer who waits for the said vehicle while it is being repaired, wherein the amenities are selected from the: a resting space, an entertaining facility, a car care education facility, a car care products selection facility, a future car care service scheduling facility, or a combination thereof.

12. The method of claim 1 further comprises a step of recording data of the cosmetic defect before and after the repair.

13. The method of claim 12, wherein the data of the cosmetic defect is recorded and stored digitally.

14. A facility for repairing cosmetic defects of a vehicle comprising:
(a) a controlled perimeter for positioning the vehicle or an area around the cosmetic defect of the vehicle;
(b) environmental control devices for regulating environmental elements within the controlled perimeter, wherein the environmental elements comprise liquid, air, temperature, light, radiation, humidity, or a combination thereof;
(c) a data acquisition means for acquiring repair data on the cosmetic defect of the vehicle within the controlled perimeter;
(d) a computing device for entering the repair data;
(e) a first database for retrieving one or more repair specification, wherein the first database is located in said computing device or located in a host computer in communication with said computing device;
(f) a computer program for estimating repair cost based on the repair specification;
(g) an authorization device for obtaining an authorization to repair the cosmetic defect based on said repair cost and the repair specification; and
(h) a repair means for repairing the cosmetic defect based on the repair specification within 0.1 to 8 hours.

15. The vehicle repair facility of claim 14, wherein the facility is stationary.

16. The vehicle repair facility of claim 14, wherein the facility is mobile.

17. A hub-satellite quick repair system for repairing cosmetic defects of a vehicle comprising two or more quick repair facilities of claim 14 in communication with a central control facility, wherein said central control facility comprises a communication means for communicating with the quick repair facilities in the system, storage facilities for storing repair equipments, materials or ingredients for preparing said repair materials, and a transportation means to supply said quick repair facilities with said materials, said ingredients, said repair equipments, or a combination thereof.
